(19) United States
(12) Patent Application Publication
(10) Pub. No.: US 2006/0176937 A1
(43) Pub. Date: Aug. 10, 2006

(54) Method for rake finger placement with reliable path detection

(76) Inventors: Mauro Bottero, Mougins Le Haut (FR); Jean-Xavier Canonici, Le Cannet (FR); Manfred Zimmermann, Munchen (DE)

Correspondence Address: ESCHWEILER & ASSOCIATES, LLC;NATIONAL CITY BANK BUILDING, 629 EUCLID AVE., SUITE 1210, CLEVELAND, OH, 44114, US

(21) Appl. No.: 11/335,417

(22) Filed: Jan. 19, 2006

(30) Foreign Application Priority Data
Jan. 20, 2005 (DE) DE 102005002801.2

(51) Int. Cl. H04B 1/707

(52) U.S. Cl. 375/147

(57) ABSTRACT

In the method for rake finger placement in a receiver, a delay profile of a multipath transmission channel is determined, wherein the signal strength is distributed over a plurality of delay times in at least one path component in the delay profile. At least a part of the at least one path component is removed or reduced by utilizing an impulse response characteristic of the path component in the delay profile. Following this, the rake fingers of the receiver are placed using the modified delay profile.

### REFERENCE TO RELATED APPLICATIONS

This application claims the benefit of the priority date of German application DE 10 2005 002 801.2, filed on Jan. 20, 2005, the contents of which are herein incorporated by reference in their entirety.

### FIELD OF THE INVENTION

The invention relates to a method for rake finger placement in a CDMA (code division multiple access) rake receiver. The invention also relates to a corresponding device for rake finger placement in a CDMA rake receiver.

### BACKGROUND OF THE INVENTION

In W-CDMA (wideband code division multiple access) systems of the third mobile radio generation, particularly UMTS (universal mobile telecommunications system) systems, code division multiple access (CDMA) is used as a multiple access method. In CDMA, a plurality of subscribers occupy the same frequency band but the radio signal is coded differently for or by each subscriber, respectively. The different CDMA coding provides for subscriber separation. In CDMA coding, a subscriber-specific CDMA spreading code is impressed on each data symbol of the digital data signal to be transmitted at the transmitter. The elements of the CDMA spreading code sequence used for this purpose are called chips, the symbol period being a multiple of the chip period.

After being radiated, the CDMA-coded transmit signal is generally subject to multiple-path propagation. Due to reflections, dispersion and diffraction of the transmitted radio signal at various obstacles in the propagation path, the transmitted signal reaches the receiver via a multiplicity of transmission paths. At the receiver, a number of received signal versions, which are displaced with respect to one another in time and are differently attenuated interfere in accordance with the number of transmission paths. The temporal spreading of the energy of the signal, which accompanies the interference of a number of transmission paths, is also called multipath spreading.

A rake receiver is frequently used as CDMA receiver. A CDMA rake receiver comprises a multiplicity of so-called rake fingers, one rake finger in each case being allocated to one transmission path, and thus to one received signal version, in the ideal case. In each rake finger, the received signal is first despread with the spreading code at the chip clock rate. In this process, the received signal or, as an alternative, the spreading code is individually displaced in time for each rake finger in accordance with the delay of the transmission path allocated to the rake finger. The despread signals of the individual rake fingers are then weighted in a so-called maximum ratio combiner (MRC) at the symbol clock rate in accordance with the attenuation of the transmission path and superimposed. The gain resulting from the superposition of the output signals of the rake fingers is also called multipath diversity gain.

The so-called rake finger placement, i.e. the determination and adjustment of the appropriate time delay in the individual rake fingers represents a particularly difficult technical challenge, the time delay set determining the allocation of a rake finger to a transmission path. The rake finger placement is generally based on a three-stage approach:
1. In a first step, a so-called power delay profile (PDP) of the transmission channel is determined. The PDP specifies the distribution of the received power to the individual transmission paths in each case having a different delay and attenuation. During this process, the respective power component of the input signal as a function of the path delay is determined. The input signal is a pilot signal known in the receiver, for example, in the case of a UMTS receiver, pilot sequences of the P-CPICH (primary common pilot channel) which comprise chips known at the receiving end. The PDP determination is based on a correlation of the received pilot signal with the pilot sequence stored in the receiver. For the correlation, a filter is used, the filter coefficients of which correspond to the conjugate complex sample values of the pilot sequence. After the squaring of the filter output signal, power peaks are produced in the resultant PDP at the time intervals corresponding to the respective delays of the path components of the transmission channel.
2. Due to power fluctuations with regard to the individual path components, for example in the case of fading, formation of a moving average is performed over a number of PDP estimations in a second step. Furthermore, the average of noise components with randomly high power is reduced by the averaging. The moving average can be formed, for example, with the aid of a moving window.
3. Finally, in a third step, the actual finger placement (FP) is performed, in which, in the FP algorithm forming the basis of the finger placement, the path components of the received signal which are essential for the signal detection are identified and the fingers are allocated to the respective delays of the path components. A restriction to the essential path components is necessary since the number of fingers is limited.

The performance of the FP algorithm is particularly critical with regard to reliable finger placement. It is the aim of the algorithm to assign the individual rake fingers to those path components which have the highest power components so that the greatest possible proportion of the received signal power distributed over a multiplicity of path components is superimposed in the MRC. In this process, the rake fingers should only be allocated to those path components the power of which is distinctly higher than the noise level. This is because, if a rake finger is processing a very noisy path component or even pure noise, this can lead to impairment of the multipath diversity gain and of the bit error rate (BER) referred to the output of the MRC. For the rest, such finger placement represents a waste of a rake finger which could otherwise be gainfully used. In this connection, a compromise must generally be made between the effort of including the multiplicity of the path components and the effort not to process very noisy path components. It is thus possible to use all path components in the rake receiver and in this case some rake fingers are possibly mainly processing noise. As an alternative, it possible largely to eliminate the processing of noise and in this case there is a reduced probability that the essential path components will be taken into consideration.

The FP algorithm is usually based on the power values of the PDP being compared with a threshold value ρ in the PDP for detecting the essential path components. The comparison makes it possible to distinguish high-power essential path components with a power above the threshold value ρ and low-power path components without noticeable contribution or noise with a power below the threshold value ρ. In most cases, the threshold value ρ is determined in dependence on the noise component in the PDP. For example, the threshold value ρ can be calculated in dependence on the expected value μ and the standard deviation σ of the noise as follows:
ρ=μ+x·σ (1)
where the quantity x describes a selectable parameter.

The use of a threshold value ρ, described above, for detecting the essential path components in the PDP is shown in FIG. 1. The left-hand diagram in FIG. 1 shows a PDP, where the power component P(k) of the received total power is represented over the delay k. In the right-hand diagram in FIG. 1, the probability distribution of the power is shown separated according to noise component and path component. Powers P(k) marked with squares are allocated to certain path components whereas power components P(k) marked with circles only represent noise. If the threshold value ρ (ρ≈ρ+1, 5·σ) shown in FIG. 1 is used as a basis in the FP algorithm, the path components at k=2 and at k=9 are detected with power values P(k) greater than the threshold value ρ. Similarly, however, the power value associated with the noise at k=5 is also detected.

Threshold-value-based approaches for detecting the high-power path components exhibit the disadvantage that the probability pnp (probability of non-detection) of overlooking an essential path component and the probability pfa (probability of false alarm) of misdetection of a path component—also called false alarm rate—cannot be minimized at the same time . . . To reduce the BER, the trend is to use a lower threshold value ρ which results in a lower value for the probability pnp, i.e. the relevant path components are detected. At the same time, however, a relatively high value is produced for the false-alarm rate pfa. If a rake finger placement is effected on the basis of such a detection result, the trend will be that the number of rake fingers is too high. This results in unnecessary demand for additional chip area and increased consumption of dissipated power.

Apart from the misdetection of a noise-based power component, secondary peaks of a transmission path, also caused by signal shaping by the transmit and the receiver filter, can be similarly erroneously detected in a threshold-based approach. In the PDP, the power variation for a particular path component is a result of the impulse response of the transmission path, i.e. the power variation for a path component is a result of the product of the convolution of the impulse response of the signal shaping at the transmitting end, the attenuation of the particular transmission path and the impulse response of the signal shaping at the receiving end up to the input of the unit for determining the PDP. In this context, the impulse response of the signal shaping at the receiving end, in particular, has a significant influence on the impulse response of a transmission path. In UMTS, so-called root raised cosine filters (RRC) are typically used as transmit and receive filters which significantly determine the signal shaping at the transmitting and receiving end.

FIG. 2 shows an exemplary variation of the square of the impulse response for any transmission path. The y values are values of a power-related quantity P(k). The variation is normalized with P(0)=1. The x values of the delay k are shown with two-fold oversampling, i.e. two time increments k correspond to one chip period. The curve variation has a main peak 1 with maximum power at the delay k=0 and a multiplicity of secondary peaks 2a/b, 3a/b, 4a/b with low power values at delays k=±3, ±5, ±7. The secondary peaks 2a/b at k=±3 are called first-order secondary peaks whereas the secondary peaks 3a/b at k=±5 are called second-order secondary peaks.

If there is a multiplicity of path components, the PDP is obtained as a superposition of individual variations as shown in FIG. 2 which are delayed or weighted in time in accordance with the path delay and the path attenuation. FIG. 3 shows a resultant PDP with three path components a, b, c, the energy of the path components a, b, c, being distributed around the path delays, i.e. around the delays of the main peaks 11, 21, 31 of the three path components at k=0, 20, 40 due to the signal shaping by the transmit filter and the receive filter. The PDP also exhibits additional noise.

If a threshold-value-based FP algorithm with the threshold value ρ drawn in FIG. 3 is used for detecting the path components, the delays of those local peaks are detected which are greater than the threshold value T. In this case, for example, the peaks at k=−3, 0, 3, 7, 17, 20, 23, 40 and 77 are selected. The selected delays of the main peaks 11, 21, 31 at k=0, 20, 40 then correspond to the path delays of the three path components. The remaining selected delays at k=−3, 0, 3, 7, 17, 23, 77 are allocated either to secondary peaks 12a, 12b, 13b, 22a, 22b or to noise. Thus, the delays of all path components are detected (pdp=0), but the present detection result with pfa=2/3 exhibits a high rate of false alarms since 6 of the 9 selected delays are not allocated to the main peaks of the path components.

However, it is the aim of the FP algorithm to adjust the rake fingers only to the detected delays of the main peaks 11, 21, 31 at k=9, 20, 40. If the fingers are additionally adjusted to the delay of the secondary peaks, a number of fingers (in this case up to 3 fingers) are aligned to the same path component which generally leads to a deterioration in the multipath diversity gain and thus to an impairment of the bit error rate referred to the output of the MRC.

With respect to FIG. 3, it should be pointed out that the threshold value ρ for reducing the proportion of false alarms pfa cannot be selected higher since the powers of the path components can be distinctly lower in the case of signal fading. If the threshold value ρ were to be increased, it might be possible, for example, that the path components c at k=40 can no longer be detected by the FP algorithm. In this case, the multipath diversity gain would be reduced.

### SUMMARY OF THE INVENTION

The following presents a simplified summary in order to provide a basic understanding of one or more aspects of the invention. This summary is not an extensive overview of the invention, and is neither intended to identify key or critical elements of the invention, nor to delineate the scope thereof. Rather, the primary purpose of the summary is to present one or more concepts of the invention in a simplified form as a prelude to the more detailed description that is presented later.

On the basis of the problems described above, the present invention is directed to a method for rake finger placement in a CDMA rake receiver with a multiplicity of transmission paths, which works with high reliability with a spreading of the received signal strength of an individual path component caused by signal shaping at the transmitting and/or receiving end. In particular, the method is intended to prevent rake fingers from being adjusted to the delay intervals of a secondary peak in the presence of secondary peaks in the delay profile. In addition, the invention is directed to a device operating accordingly.

The method according to the invention for rake finger placement in a CDMA rake receiver comprises determining a delay profile, typically a power-related PDP, of a multipath transmission channel that forms the basis of the radio transmission. The delay profile specifies the distribution of the received signal strength, particularly of the received power, over a multiplicity of transmission paths. Instead of power values, the delay profile can also be based on amplitude values. The delay profile comprises at least one path component, the signal strength of which is distributed over a multiplicity of delay times. The method further comprises removing at least a part of the at least one path component in the delay profile. For example, the signal strength of this part of the at least one path component is distinctly reduced. In one example, the removal is done by utilizing an assumed impulse response, characteristic of the path component, or a part of such an impulse response. Further, at least one rake finger of the rake receiver is placed on a delay time which is outside the delay time (in the case of only one sample value within the removed part) or, respectively, delay times of the part essentially removed from the at least one path component. The reason for rake receiver placement is that the path component part essentially removed can no longer be detected due to the distinctly reduced signal strength.

The basic concept of the method according to the invention is to calculate out of the delay profile a widening of the path components over a multiplicity of time intervals caused by the signal shaping over the transmission path with knowledge of the impulse response of an individual transmission path (including the essential influence of the transmitter and of the receiver). If the actual finger placement is performed on the basis of a delay profile corrected in this manner, the peaks of the path components are detected with high reliability and the rake fingers are precisely adjusted to the delay associated with the peaks.

A path component typically comprises in each case a path-specific main peak and path-specific secondary peaks, surrounding the main peak, at different delay times. In this case, in the method at least one secondary peak of the path component in the delay profile is preferably removed. Due to this measure, the actual finger placement is prevented from erroneously adjusting a rake finger to the delay of the secondary peak. As already explained above, this would be disadvantageous for the receiver, in particular, there would be a reduction in the multipath diversity gain.

According to one embodiment of the invention, the entire path component, i.e. both the main peak and the secondary peaks, is essentially removed from the delay profile in the second act of the method. Calculating the path component out of the delay profile is done with knowledge of the impulse response characteristic of the path component. The resultant delay profile forms the starting point for subsequent acts of the method.

For removing the entire path component, in one example the path component is first detected in the delay profile. Following that, the signal strength values of the path component are reduced by subtracting signal strength values resulting from the impulse response characteristic of the path component. To obtain these subtracting signal strength values, signal strength values of an impulse response identical for all path components are scaled in accordance with the maximum signal strength of the detected path component. The signal strength values are typically scaled in such a manner that the peak of the scaled signal strength values of the impulse response identical for all path components (e.g., at k=0 in FIG. 2) corresponds to the maximum signal strength value of the main peak of the path component.

In one example, a multiplicity of path components is essentially removed out of the delay profile. It is conceivable in this case either to remove a path component in each case and then place a rake finger in each case or first to remove a multiplicity of path components and then to place a multiplicity of rake fingers. In the repeated detection of the individual path components, the maximum signal strength and the associated path delay are detected in each case in the delay profile.

Thus, the main peak with the maximum power is in each case detected and the associated path component removed from the delay profile with each detection. Following this, the path components are successively detected with reducing power of the respective main peak and removed. If in an iteration, a path component with the maximum power is detected and removed with the associated secondary peaks, the secondary peaks of the path component removed in the previous iteration will not disturb the search for the main peak with the next lower power in the next iteration. This also applies when the maximum power of the main peak is lower than the maximum power of the secondary peaks removed in the previous iteration.

In accordance with an advantageous embodiment of the invention, the repeated detecting and removing of a path component is discontinued when the maximum signal strength in the delay profile is below a particular threshold value during the detection of a path component. In this case, this signal strength value must be typically allocated to the noise. The threshold value can be determined as noise-related threshold value in dependence on the noise component in the delay profile. As an alternative or additionally, the repeated detecting and removing of a path component can be discontinued when a fixed number of path components has been removed. This fixed number of path components advantageously corresponds to the number of rake fingers to be placed by means of the method.

Advantageously, the impulse response characteristic of the respective path component describes the transmission characteristic of the signal shaping at the transmitting end and/or the receiving end, particularly up to the input of the FP circuit block. With regard to the signal shaping at the receiving end, the influence both of the analogue front end and of the digital front end (i.e. the filter stages after the digital/analogue filter) may be advantageously taken into consideration.

In one example, the impulse response characteristic of the respective path component is restricted in its length. The length is selected in such a manner that the secondary peaks of the first order at a maximum or, as an alternative, the secondary peaks of the first and, at a maximum, the second order, are essentially removed. Referring to FIG. 2, for example, this means that the length of the restricted impulse response is typically 3-4 chip periods (i.e., 6 to 8 time increments with two-fold oversampling) or, respectively, 5-6 chip periods (i.e., 10 to 12 time increments with two-fold oversampling).

Advantageously, the main peak or a part of the main peak comprising the maximum of the main peak is supplemented for each removed path component in the delay profile. In this case, the actual finger placement is performed by means of the appropriately supplemented delay profile. This delay profile only exhibits the main peaks or, respectively, the maxima of the main peaks of the path components apart from the noise. It thus impossible to place a rake finger on the delay of a secondary peak.

As an alternative, the delays of the peaks detected in the second act of the method can also be used directly for finger placement.

Advantageously, in one example the method according to the invention for rake finger placement is used in a W-CDMA receiver, particularly in a UMTS receiver.

The device according to the invention for rake finger placement in a CDMA rake receiver comprises a means for determining a delay profile, the delay profile comprising, at least for one transmission path, a path component, the signal strength of which is distributed over a multiplicity of delay times. Furthermore, a means for removing at least a part of the at least one path component is provided in the device according to the invention. This means utilizes an assumed impulse response characteristic of the path component or a part of such an impulse response. In addition, a means for the actual placement of the rake fingers of the rake receiver is provided in the device according to the invention. With the aid of this means, the fingers are in each case placed onto a delay time which is outside the delay times of the essentially removed part of the at least one path component, since the associated signal strength values essentially have been removed from the delay profile and thus are no longer detected.

The advantageous embodiments of the method, described above, can be analogously transferred also to the device according to the invention.

To the accomplishment of the foregoing and related ends, the invention comprises the features hereinafter fully described and particularly pointed out in the claims. The following description and the annexed drawings set forth in detail certain illustrative aspects and implementations of the invention. These are indicative, however, of but a few of the various ways in which the principles of the invention may be employed. Other objects, advantages and novel features of the invention will become apparent from the following detailed description of the invention when considered in conjunction with the drawings.

### BRIEF DESCRIPTION OF THE DRAWINGS

In the text which follows, the invention will be explained in greater detail with reference to two illustrative embodiments, referring to the drawings, in which:

FIG. 1 is a prior art diagram illustrating a PDP diagram on the left and a power probability distribution on the right;

FIG. 2 is a prior art graph illustrating a variation of the square of the impulse response for an arbitrary transmission path;

FIG. 3 is a prior art graph illustrating a PDP with assumption of the variation of the square of the impulse response shown in FIG. 2;

FIG. 4 is a block diagram illustrating a signal flow for a first illustrative embodiment of the method according to the invention; and

FIG. 5 is a block diagram illustrating a signal flow for a second illustrative embodiment of the method according to the invention.

### DETAILED DESCRIPTION OF THE INVENTION

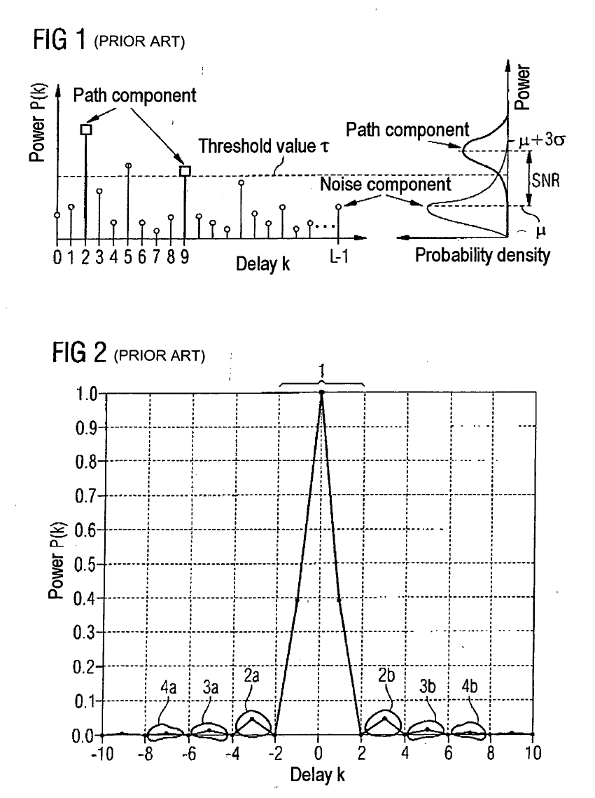

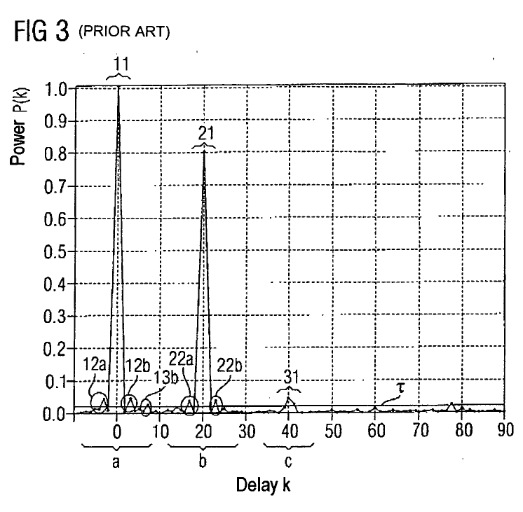

With regard to FIGS. 1 to 3, reference is made to the statements in the introduction to the description.

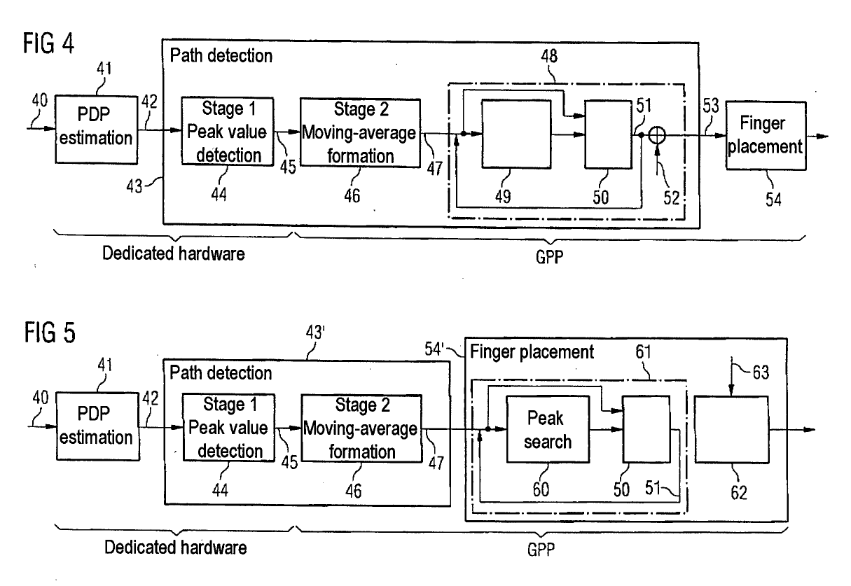

FIG. 4 illustrates a signal flow diagram for a first illustrative embodiment of the method according to the invention. While the exemplary method is illustrated and described below as a series of acts or events, it will be appreciated that the present invention is not limited by the illustrated ordering of such acts or events. For example, some acts may occur in different orders and/or concurrently with other acts or events apart from those illustrated and/or described herein, in accordance with the invention. In addition, not all illustrated steps may be required to implement a methodology in accordance with the present invention.

A digital pilot signal 40, filtered at the receiving end, which contains pilot sequences, is initially subjected to a PDP estimation 41. With regard to more accurate information relating to the PDP estimation 41, reference is made to the introduction to the description. The resultant PDP 42 is then used as an input variable for a path detection 43. It is the task of the path detection 43 to distinguish between high-power path components, on the one hand, and, on the other hand, noise peaks, weak path components or secondary peaks in the PDP 42.

For the path detection 43, a three-stage approach is selected. Firstly, a preselection of possible path delays is made by means of a peak value detection 44 (stage 1). In this process, the sample values with high power are detected as a result of which the number of sample values is reduced for the subsequent signal processing steps. The resultant PDP 45 with a reduced number of sampling points is used as an input variable for forming a moving average 46 (stage 2). The moving-average formation 46 processes the PDP 45 for a multiplicity of PDP estimations 41. As a result, compensation is made for power fluctuations. The moving-average formation 46 works similarly to a moving histogram.

The resultant time-averaged PDP signal 47 forms the input variable for a shadow path removal 48. The shadow path removal 48 is used for suppressing secondary peaks in the PDP signal 47. In the prior art, shadow path removal is done by means of a threshold value which is selected in dependence on the main peak with the highest power. In the method according to the invention, the shadow path removal 48 is done iteratively. For this purpose, the peak in the PDP 47 is detected by means of a peak search 49. This peak is allocated to the main peak with maximum power in the PDP 47. If the delay and the power value of the main peak and the typical impulse response for a path component are known, the path component allocated to the detected main peak can be calculated out of the PDP 47 during a path component removal 50. For this purpose, the power values of the impulse response are scaled in accordance with the power value of the peak and subtracted from the PDP 47.

In the resultant PDP 51, the detected path component is then no longer present. After that, the resultant PDP 51 is iteratively subjected to a new peak search 49 and a new path component removal 50. As a result, the path components with decreasing power are successively removed from the PDP. Overall, the N path components with the highest power are iteratively removed from the PDP. The number N is a constant and corresponds to the assumed maximum number of path components of a radio cell.

Following this, the stored peaks 52 of the main peaks are supplemented again for each removed path component in the PDP 51. In the resultant PDP 53, the secondary peaks of the N path components with the highest power are thus removed. In distinction from the shadow path removal by means of a threshold value, known from the prior art, no complete path components with low power are removed in the shadow path removal 48 according to the invention. The PDP 53, removed around the disturbing secondary peaks for the finger placement, is subsequently supplied to the actual finger placement 54. The finger placement 54 sets the delays of the fingers of the rake receiver by means of the PDP 53. For this purpose, the path components in the resultant PDP 53 are detected in the finger placement by comparison with a threshold value dependent on the noise of the PDP 53.

The method shown in FIG. 4 is partially performed by means of dedicated hardware and partially by means of software on a general purpose processor (GPP). As shown in FIG. 4, the PDP estimation 41 and the peak value detection 44 are implemented by means of dedicated hardware. Due to the complexity of these method steps, the subsequent stages, namely the moving-average formation 46, the shadow path removal 48 and the actual finger placement 54 are carried out on a GPP, for example on a DSP (digital signal processor) or a microcontroller.

FIG. 5 shows a signal flow diagram for a second illustrative embodiment of the method according to the invention. Signals and method steps provided with the same reference symbols in FIG. 4 and FIG. 5 correspond to one another. In distinction from the signal flow diagram shown in FIG. 4, the path detection 43′ in FIG. 5 only comprises two stages, namely the peak value detection 44 and the moving-average formation 46. The PDP 47 generated by the path detection 43′ comprises both the main peaks and the secondary peaks of all path components detected in the peak value detection 44. The PDP 47 is supplied to a finger placement 54′. The finger placement 54′ can be subdivided in one example into a path search 61 and a finger assignment 62. Within the path search 54′, a peak search 60 is first performed with respect to the PDP 47. The peak search 60 only occurs above a threshold value dependent on the noise of the PDP. The peak thus determined is allocated to the main peak with maximum power in the PDP 47. If the delay and the power value of the main peak and the impulse response of the path component are known, the path component allocated to the detected main peak can be calculated out of the PDP 47 during a path component removal 50, similar to FIG. 4. After that, the resultant PDP 51 is subjected to a new peak search 60 and path component removal 50. During this process, the probability is very high that a main peak of a path component with the next-lower power is detected instead of a secondary peak with higher power. Thus, the path components with decreasing power are removed from the PDP in the course of a multiplicity of iterations.

The iteration loop is ended when either the remaining power values in the resultant PDP 51 are lower than the threshold value dependent on the noise of the PDP or a maximum number of N path components has been calculated out of the PDP. The delays 63 of the path components calculated out, which have in each case been determined during the peak search 60, are used in the finger assignment 62 in order to assign in each case a single rake finger to the individual delays 63.

As shown in FIG. 5, the PDP estimation 41 and the peak value detection 44 are implemented by means of dedicated hardware. Due to the complexity of these method steps, the subsequent stages, namely the moving-average formation 46 and the actual finger placement 54′ are performed preferably on a GPP.

The two illustrative embodiments shown in FIG. 4 and FIG. 5 are based on the inventive iterative approach of successively calculating the path components out of the PDP and, therefore, are very similar. An essential difference between the first and second illustrative embodiment is that in the first illustrative embodiment according to FIG. 4, a constant number N of path components calculated out of the PDP is used as a basis whereas in the second illustrative embodiment, the number of essential path components actually present is calculated out of the PDP. Assuming that the number of actual path components is statistically an equally-distributed random variable between 0 and N, only half as many iterations as in the first illustrative embodiment are needed on average in the second illustrative embodiment. Since the performance of the finger placement is approximately identical in the two illustrative embodiments, the low number of iterations results in a preference for the second illustrative embodiment.

It should be pointed out that the signal flow diagrams shown in FIG. 4 and FIG. 5 can be analogously also interpreted as illustrative embodiments of the device according to the invention for rake finger placement. The above statements with respect to the illustrative embodiments of the method according to the invention can be analogously also transferred to corresponding illustrative embodiments of the device according to the invention.

A precise removal of the path components out of the PDP requires a sufficiently accurate estimation of the impulse response of a path component. In this connection, the impulse response may describe the signal transmission up to the input signal 40 of the finger placement. The signal shaping at the receiving end exhibits a significant influence on the impulse response in this respect. In consequence, the analogue and the digital receiver front end should be characterized as accurately as possible with regard to the signal transmission characteristics. The impulse response of a path component can be determined by measurement. For this purpose, a single path component with very high power and the least possible noise should be generated at the receiving end. This can be done, for example, by placing a base station or a measurement transmitter directly next to one another. The measuring can then be controlled via the GPP in the receiver in dependence on a software routine, the measured power values of the PDP being normalized at various delay values as in FIG. 2 and stored in the form of a table. Table 1 shows an example of such a table.

TABLE 1

| | Delay time increment | | | | | | |
|---|---|---|---|---|---|---|---|
| | −5 | −3 | −1 | 0 | 1 | 3 | 5 |
| Normalized | 1.1 × 10⁻² | 4.4 × 10⁻² | 3.9 × 10⁻¹ | 1 | 3.9 × 10⁻¹ | 4.4 × 10⁻² | 1.1 × 10⁻² |
| power | | | | | | | |
| Normalized | −19.6 | −13.6 | −4.1 | 0 | −4.1 | −13.6 | −19.6 |
| power in dB | | | | | | | |

While the invention has been illustrated and described with respect to one or more implementations, alterations and/or modifications may be made to the illustrated examples without departing from the spirit and scope of the appended claims. In particular regard to the various functions performed by the above described components or structures (assemblies, devices, circuits, systems, etc.), the terms (including a reference to a “means”) used to describe such components are intended to correspond, unless otherwise indicated, to any component or structure which performs the specified function of the described component (e.g., that is functionally equivalent), even though not structurally equivalent to the disclosed structure which performs the function in the herein illustrated exemplary implementations of the invention. In addition, while a particular feature of the invention may have been disclosed with respect to only one of several implementations, such feature may be combined with one or more other features of the other implementations as may be desired and advantageous for any given or particular application. Furthermore, to the extent that the terms “including”, “includes”, “having”, “has”, “with”, or variants thereof are used in either the detailed description and the claims, such terms are intended to be inclusive in a manner similar to the term “comprising”.

1. A method for rake finger placement in a rake receiver, comprising:
determining a delay profile of a multipath transmission channel forming the basis of a received radio signal, wherein the delay profile specifies a distribution of the received signal strength over a plurality of transmission paths and which comprises, at least for one transmission path, a path component, the signal strength of which is distributed over a plurality of delay times;
removing or reducing at least a part of the at least one path component in the delay profile utilizing an impulse response that is characteristic of the path component, or a part of such an impulse response; and
placing at least one rake finger of the rake receiver on a delay time associated with the delay time of the removed path component part.

2. The method of claim 1, wherein the at least one path component comprises a path-specific main peak and path-specific secondary peaks surrounding the main peak at different delay times, and wherein at least one secondary peak of the at least one path component in the delay profile is removed or reduced.

3. The method of claim 2, wherein removing or reducing at least a part of the at least one path component comprises removing or reducing the path component from the delay profile based on the impulse response characteristic of the path component, and wherein the resultant delay profile thereafter represents the delay profile for subsequent method actions.

4. The method of claim 3, wherein removing or reducing at least a part of the at least one path component comprises:
detecting the path component to be removed in the delay profile; and
reducing the signal strength values of the path component by subtracting therefrom signal strength values resulting from the impulse response characteristic of the path component.

5. Method of claim 4, further comprising scaling the signal strength values of the impulse response corresponding to a maximum signal strength of the detected path component prior to the reduction of the signal strength values.

6. The method of claim 5, wherein detecting the path component comprises determining the maximum signal strength in the delay profile.

7. The method of claim 6, wherein no further path components are removed or reduced when the maximum signal strength is below a predetermined threshold value.

8. The method of claim 6, wherein no further path components are removed or reduced when a fixed number of path components has been removed.

9. The method of claim 3, wherein removing or reducing at least a part of the at least one path component is repeated several times on the resultant delay profile, wherein each time another path component is removed or reduced from the resultant delay profile.

10. The method of claim 1, wherein the impulse response characteristic of the respective path component describes the transmission characteristic of the signal shaping at the transmitting end or the receiving end of a transmission system, or both.

11. The method of claim 10, wherein the impulse response characteristic of the respective path component is restricted in its length, the length being selected in such a manner that in removing or reducing at least a part of the path component, the secondary peaks of the first order or the secondary peaks of the first and the second order are removed reduced.

12. The method of claim 3, further comprising supplementing the main peak or a part of the main peak comprising the maximum of the main peak for each removed path component back into the resultant delay profile prior to rake finger placement, wherein the finger placement is performed using the supplemented resultant delay profile.

13. The method of claim 6, wherein the finger placement is effected by means of the delay times of the maximum signal strengths of the detected path components, respectively.

14. The method of claim 1, wherein the method for rake finger placement is used in a W-CDMA receiver.

15. A method for placement of at least one rake finger in a rake receiver, comprising:
determining a delay profile of a multipath transmission channel based on a radio transmission signal, wherein the delay profile specifies the distribution of the received signal strength over a plurality of transmission paths and which comprises, at least for one transmission path, a path component which comprises a main peak and secondary peaks surrounding the main peak;
removing or reducing at least one secondary peak of the at least one path component in the delay profile utilizing an impulse response characteristic of the path component or a part of such an impulse response, thereby forming a modified delay profile; and
placing at least one rake finger of the rake receiver on a respective delay based on the modified delay profile.

16. The method of claim 15, further comprising removing or reducing the main peak and the secondary peaks of the path component from the delay profile to form the modified delay profile.

17. The method of claim 16, wherein removing or reducing a peak of the path component comprises reducing the signal strength values of the respective path component by subtracting-signal-strength values which result from the impulse response characteristic of the path component.

18. The method of claim 16, further comprising removing or reducing a number of path components successively from the delay profile.

19. The method of claim 16, further comprising detecting the path component by determining the maximum signal strength in the delay profile before the removal of the path component from the delay profile.

20. The method of claim 19, further comprising repeating the detection and reduction or removal of path components, and discontinuing the repeating when the maximum signal strength of the remaining path components is below a particular threshold value, or when a fixed number of path components has been removed.

21. The method of claim 16, further comprising supplementing the maximum of the main peak for the removed path component into the delay profile to further modify the delay profile before the placement of the at least one rake finger.

22. A device for rake finger placement in a rake receiver, comprising:
means for determining a delay profile of a multipath transmission channel based on a radio transmission signal, the delay profile describing the distribution of the received signal strength over a plurality of transmission paths and comprising, at least for one transmission path, a path component, the signal strength of which is distributed over a plurality of delay times;
means for removing or reducing at least a part of the at least one path component in the delay profile utilizing an impulse response characteristic of the path component or a part of such an impulse response; and
means for placing at least one rake finger of the rake receiver onto a delay time associated with the removed part of the at least one path component.

23. The device of claim 22, wherein the at least one path-component comprises a path-specific main peak and path-specific secondary peaks surrounding the main peak at different delay times, and wherein at least one secondary peak of the at least one path component in the delay profile is removed or reduced.

24. The device of claim 23, wherein the path component is removed or reduced from the delay profile based on the impulse response characteristic of the path component.

25. The device of claim 24, further comprising means for supplementing the main peak or a part of the main peak for the removed or reduced path component into the delay profile.

26. A device for placement of rake fingers in a rake receiver, comprising:
a determining device configured to determine a delay profile of a multipath transmission channel based on a radio transmission signal, the delay profile describing the distribution of the received signal strength over a plurality of transmission paths and comprising, at least for one transmission path, a path component which comprises a main peak and secondary peaks surrounding the main peak;
a removing device configured to remove or reduce at least one secondary peak of the at least one path-component in the delay profile, the at least one secondary peak being removed or reduced utilizing an impulse response characteristic of the path component or a part of such an impulse response, thereby forming a modified delay profile; and
a placing device configured to place at least one rake finger of the rake receiver based on the modified delay profile.

27. The device of claim 26, wherein the path component is removed or reduced from the delay profile based on the impulse response characteristic of the path component.

28. The device of claim 27, further comprising a supplementing device configured to supplement the main peak or a part of the main peak comprising the maximum of the main peak for the removed path component back into the modified delay profile thereby further modifying the delay profile.
